(19) United States
(12) Patent Application Publication
(10) Pub. No.: US 2018/0320558 A1
(43) Pub. Date: Nov. 8, 2018

(54) DEVICE FOR CONVERTING THERMAL ENERGY IN HYDROCARBONS FLOWING FROM A WELL INTO ELECTRIC ENERGY

(71) Applicant: Heerema Marine Contractors Nederland SE, Leiden (NL)

(72) Inventors: Tom Laurent Hubert FRIJNS, Leiden (NL); Cornelis VAN ZANDWIJK, Leiden (NL); Remi BLOKKER, Delft (NL); Berend-Jan KLEUTE, Delft (NL)

(73) Assignees: Heerema Marine Contractors Nederland SE, Leiden (NL); Heerema Marine Contractors Nederland SE, Leiden (NL)

(21) Appl. No.: 15/772,917

(22) PCT Filed: Nov. 8, 2016
(86) PCT No.: PCT/NL2016/050778

§ 371 Date: May 2, 2018

(30) Foreign Application Priority Data
Nov. 12, 2015 (NL) 2015780

(51) Int. Cl. F01K 13/00; E21B 41/00; F01K 25/10; F01K 7/16; F01D 15/10; F03G 7/04

(52) U.S. Cl. CPC F01K 13/00; E21B 41/00; F01K 25/106; F05D 2260/231; F01D 15/10; F03G 7/04; F05D 2220/76; F01K 7/16

(57) ABSTRACT

A system for generating electrical energy comprises a circuit containing a working fluid, an evaporator configured for boiling the working fluid, a turbine driven by the vaporized working fluid, and an electric generator coupled to the turbine for creating electric energy. The system further comprises a condenser for condensing the working fluid which flows from the turbine, and a pump for pumping the working fluid through the circuit. A hydrocarbons pipeline transports hydrocarbons having a hydrocarbon temperature from a well, a seawater intake is configured for taking in seawater having a seawater temperature, and a seawater discharge is configured for discharging the seawater.

### FIELD OF THE INVENTION

The present invention relates to the field of thermal energy conversion. Various systems for converting thermal energy are known.

### BACKGROUND OF THE INVENTION

Ocean Thermal Energy Conversion (OTEC) systems are known which create electric energy from a temperature difference between deep seawater and shallow seawater. Deep seawater is generally relatively cold and shallow seawater is relatively warm, at least in tropical regions. Generally, an OTEC system comprises a closed circuit holding a working fluid. The OTEC system typically comprises a condenser, a turbine, a pump and an evaporator which are positioned along the closed circuit.

OTEC systems typically operate on the basis of a Rankine cycle. The working fluid typically is a refrigerant such as ammonia, which has a low boiling temperature. Generally a low pressure turbine is used. The turbine is coupled to an electric generator. The deep cold seawater is pumped to the surface with a pipeline and used to condense the working fluid in the condenser. The warm surface water is used to boil the working fluid in the evaporator. When the deep seawater is 5 degrees and the shallow seawater is 26 degrees, the temperature difference is sufficient to generate electric energy at an acceptable efficiency.

Although the Rankine cycle is most common for OTEC systems, other configurations are also possible, such as the Kalina cycle.

OTEC theory was first developed in the 1880s and the first bench size demonstration model was constructed in 1926. Currently a few OTEC plants are operating, amongst others in Japan and Hawaii.

However, in many areas on the planet the temperature difference between shallow seawater and deep seawater is not high enough to apply OTEC systems in an efficient manner. In those areas, the required investment does not weigh up to the amount of electrical energy that could be generated. This applies for most non-tropical areas and for most areas in which the sea is not very deep. Therefore, the use of OTEC systems remains limited.

A further known kind of thermal energy conversion is geothermal energy conversion. In geothermal energy conversion, thermal energy stored deep in the Earth is used to generate electricity. Typically, water is heated deep in the ground and rises upwards through a pipeline. The hot water evaporates into steam. The steam passes through a turbine which is coupled to an electric generator. Like OTEC systems, thermal energy conversion is only cost-effective in certain areas, in particular where sufficient thermal energy is available at limited depths.

A further but very different aspect which forms part of the background of the present invention is that the exploration and production of hydrocarbons has moved out to sea over the years. The production locations are becoming ever more remote and far from shore and may even extend to arctic areas. Furthermore, hydrocarbons are found in and produced from ever deeper formations, with associated increase in pressure and temperature.

The production and processing of hydrocarbons often requires a substantial amount of energy. Because the locations at sea are remote, this energy is often produced by burning the same hydrocarbons which are produced at the location or by burning imported diesel fuel. However, this is generally not done in very efficient way because of local constraints such as limited space, limited equipment, limited availability of human operators, high transport costs, etc. There is a need for a better way of generating energy at remote locations where hydrocarbons are produced.

### OBJECT OF THE INVENTION

It is a general object of the invention to provide an alternative method of generating electric energy.

It is a further object of the invention to provide an alternative method of generating electric energy at sea.

It is a further general object of the invention to provide an alternative method for generating electric energy on land.

It is a further object of the invention to create electric energy in an alternative manner at production locations of hydrocarbons at sea and on land.

### SUMMARY OF THE INVENTION

In order to achieve at least one object, the invention provides a system for generating electrical energy, the system comprising:
a circuit containing a working fluid:
an evaporator configured for boiling the working fluid,
a turbine driven by the vaporized working fluid and an electric generator coupled to the turbine for creating electric energy,
a condenser for condensing the working fluid which flows from the turbine, and
a pump for pumping the working fluid through the circuit,
   wherein the evaporator, the turbine, the condenser and the pump are positioned along the circuit, and
a hydrocarbons pipeline connected to a well, wherein the hydrocarbons pipeline transports hydrocarbons having a hydrocarbon temperature (T1) from the well,
a water intake configured for taking in water having a water temperature (T2), wherein the hydrocarbon temperature is higher than the water temperature,
a water discharge configured for discharging the water,
wherein the water intake is in fluid communication with a water channel in the condenser, the condenser being configured to transfer heat from the working fluid to the water to condense the working fluid, and wherein the condenser is in fluid communication with the water discharge for discharging the used water,
wherein the hydrocarbons pipeline is in fluid communication with a hydrocarbons channel in the evaporator, wherein the evaporator is configured for transferring heat from the hydrocarbons to the working fluid in the evaporator in order to boil the working fluid.

The invention advantageously provides a new source of electric energy at sea and on land. This source of energy is in particular an advantage for offshore facilities where hydrocarbons are processed. The invention may also be used in other conditions.

Hydrocarbons which are currently explored and produced have increasingly high temperatures. In recent oil fields, hydrocarbons are reported having temperatures of 150-200 degrees Celsius.

The greater the temperature difference between the hydrocarbons and the seawater is, the more efficient the energy conversion is.

The present invention provides a continuous and reliable source of electric energy as long as the hydrocarbons flow, because the temperature difference is always present.

The temperature difference is much greater than the temperature difference between deep seawater and shallow seawater. Therefore, the system according to the invention can be more efficient than traditional OTEC systems. Energy is created when cooling the hydrocarbons which is advantageous, because otherwise this energy would be lost.

The technology is environmentally clean. No emissions of CO2, NOx, SOx, particular matter or noise are created.

In an embodiment, the present invention obviates expensive electric cables between the production site and the nearest point where electric power is supplied, which is in particular advantageous in remote locations.

The system according to the invention may comprise a hydrocarbons processing installation which is positioned downstream from the evaporator, wherein the hydrocarbons are processed in the processing installation after having transferred heat to the working fluid in the evaporator.

The electric generator may be coupled to the hydrocarbons processing installation via one or more electric energy conductors, wherein electric energy which is generated by the electric generator is used by the hydrocarbons processing installation in the processing of the hydrocarbons and for pumping the processed hydrocarbons to a delivery point at sea or on land.

If the system is provided at sea, the water intake and the water discharge will be a seawater intake and seawater discharge.

The hydrocarbons processing installation and the circuit may be provided on a common offshore facility at sea.

The circuit may be located above the water level. The offshore facility may be located on a floating platform or on a platform supported by a structure which rests on the seabed.

Alternatively, the offshore facility may be located under water and rest on the seabed. In another alternative embodiment, the circuit is located on shore.

The seawater intake may be located near the subsea well. This advantageously keeps the pipelines for the hydrocarbons and the seawater short.

The evaporator may comprise an evaporator working fluid channel, a hydrocarbons channel and a heat-conducting evaporator wall which separates the evaporator working fluid channel from the hydrocarbons channel. The condenser may comprise a condenser working fluid channel, a water channel and a heat-conducting condenser wall which separates the condenser working fluid channel from the water channel.

The hydrocarbons pipeline may be covered with thermal insulation to limit heat loss during transport to the evaporator.

The well may be a subsea well. For offshore locations, the present invention is very advantageous, because often energy is not readily available at such locations.

The present invention further relates to an offshore facility comprising the system as described before.

In a further aspect, the present invention relates to a method of generating electrical energy, the method comprising:
positioning the system according to the invention near a subsea well, connecting the system to the subsea well and letting warm hydrocarbons flow through the hydrocarbons pipeline,
circulating the working fluid through the circuit,
evaporating the working fluid with the heat from the hydrocarbons in the evaporator, passing the evaporated working fluid through the turbine and creating electric energy with the turbine and the electric generator, and condensing the working fluid with the seawater in the condenser.

The method has substantially the same advantages as the system according to the invention.

The hydrocarbons may be processed in a hydrocarbons processing installation which is situated downstream from the evaporator, wherein the electric generator is coupled to the processing installation via one or more electric energy conductors, and wherein electric energy which is generated by the electric generator is used by the hydrocarbons processing installation during the processing of the hydrocarbons.

The hydrocarbons may be processed in the processing installation directly after transferring heat from the hydrocarbons to the working fluid in the evaporator.

The hydrocarbons processing installation and the circuit may be provided on the same platform.

The hydrocarbon temperature may be higher than 80 degrees, in particular higher than 120 degrees Celsius, and the seawater temperature may be lower than 25 degrees, in particular lower than 15 degrees Celsius.

These and other aspects of the invention will be more readily appreciated as the same becomes better understood by reference to the following detailed description and considered in connection with the accompanying drawings in which like reference symbols designate like parts.

### BRIEF DESCRIPTION OF THE FIGURES

FIG. 1 shows a diagrammatic view of an embodiment of the invention.

FIG. 2 shows a diagrammatic view of another embodiment of the invention.

FIG. 3 shows a diagrammatic view of another embodiment of the invention.

FIG. 4 shows a diagrammatic view of an embodiment of the invention on land.

FIG. 5 shows a diagrammatic view of a pipeline having heat insulation

FIG. 6A shows a diagrammatic view of an evaporator.

FIG. 6B shows a diagrammatic view of a condenser.

FIG. 7 shows a diagrammatic view of another embodiment according to the invention.

### DETAILED DESCRIPTION OF THE FIGURES

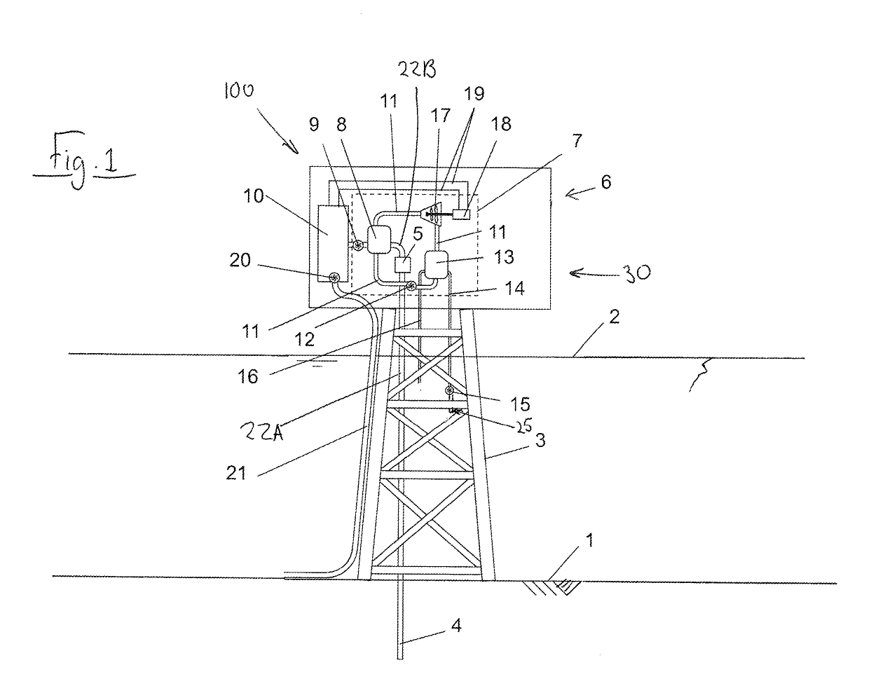

Turning to FIG. 1, a first embodiment of the invention is shown. A system 100 for generating electrical energy is provided on an offshore facility 6 which is supported by a structure 3 which rests on the seabed 1 and extends to above the water surface 2. The offshore facility 3 is positioned near a subsea well 4.

The system 100 comprises a closed circuit 11 containing a working fluid. The working fluid may be ammonia or another suitable fluid having a relatively low boiling temperature.

The system 100 comprises an evaporator 8 configured for boiling the working fluid, a turbine 17 driven by the vaporized working fluid and an electric generator 18 coupled to the turbine for creating electric energy. The system comprises a condenser 13 for condensing the working fluid which flows from the turbine, and a pump 12 for pumping the working fluid through the circuit. The evaporator 8, the turbine 17, the condenser and the pump are positioned along the circuit.

The system 100 further comprises a hydrocarbons pipeline 22 which comprises a first part 22A which extends from the well 4 to the wellhead 5 and a second part 22B which extends from the wellhead 5 to the evaporator 8. The wellhead 5 is located on top of the well 4 and comprises closure valves for closing off the well 4.

Generally, in the field of the art the subsea well 4 is considered to extend upward from the seabed to the wellhead 5. This is why 5 is called the wellhead. For this reason, the first part 22A is generally not considered to form part of a “pipeline” by persons skilled in the art. However, for the purpose of this document, the hydrocarbons pipeline 22 is defined as starting at the seabed and extending via the wellhead to the evaporator.

The hydrocarbons pipeline 22 transports hydrocarbons having a hydrocarbon temperature from the well 4 to the evaporator. The hydrocarbons pipeline 22 may be covered with thermal insulation to limit heat loss during transport of the hydrocarbons to the evaporator.

The circuit 11, evaporator 8, turbine 17, generator 18, condenser 13 and pump 12 together form a heat conversion unit 7.

The system 100 further comprises a seawater intake pipeline 14 with a pump 15, hereinafter referred to as seawater intake 25, configured for taking in seawater having a seawater temperature. The pump 15 is placed below the water line.

The hydrocarbon temperature is higher than the seawater temperature. The intake pipeline 14 extends between the seawater intake pump 15 and the condenser. The seawater intake pump 15 may be located under water and close to the water surface. The seawater intake 15 may be located near the well 4.

The system 100 further comprises a seawater discharge 16 configured for discharging the seawater back into the sea.

The seawater intake is in fluid communication with a water channel in the condenser. The condenser is configured for transferring heat from the working fluid to the seawater in the evaporator to condense the working fluid. The condenser 13 is also in fluid communication with the seawater discharge 16 for discharging the used seawater back into the sea.

The hydrocarbons pipeline 22 is in fluid communication with a hydrocarbons channel in the evaporator 8. The evaporator is configured for transferring heat from the hydrocarbons to the working fluid in the evaporator in order to boil the working fluid.

The system 100 further comprises a hydrocarbons processing installation 10 which is positioned downstream from the evaporator along the hydrocarbons pipeline. The hydrocarbons pipeline 22 extends from the evaporator to the hydrocarbons processing installation 10 for this reason. A hydrocarbons pump 9 is provided in this section of the hydrocarbons pipeline for pumping the hydrocarbons to the hydrocarbons processing installation 10.

The hydrocarbons are processed in the processing installation 10 after heat has been transferred from the hydrocarbons to the working fluid in the evaporator.

The electric generator 18 is coupled to the hydrocarbons processing installation 10 via electric energy conductors 19. The electric energy which is generated by the electric generator 18 is used by the hydrocarbons processing installation 10 in the processing of the hydrocarbons.

The hydrocarbons processing installation 10 and the circuit 11 are provided on a common platform 30 at sea. In this embodiment the circuit 11 is located above the water level 2.

The platform 30 is supported by a structure 3 which rests on the seabed 1 but may also be a floating platform.

The electricity which is generated in the electric generator 18 may be used for general purposes on the offshore facility 6, optionally in addition to the use in the hydrocarbons processing installation 10.

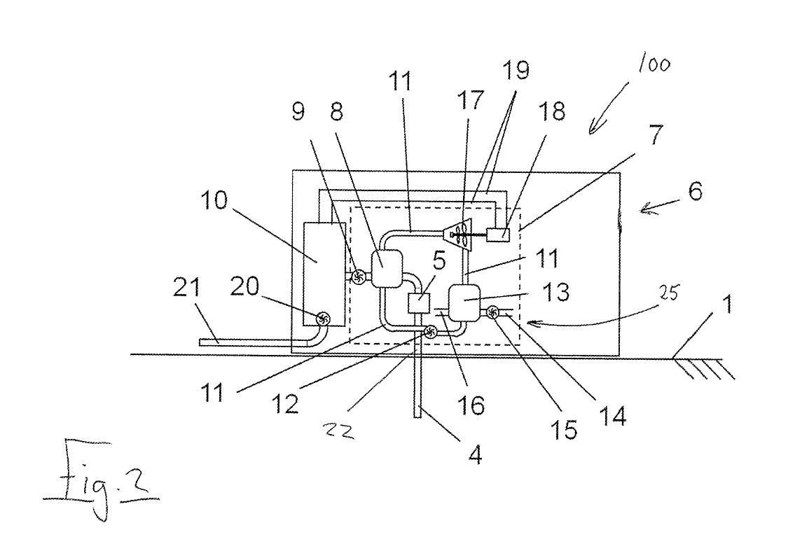

Turning to FIG. 2, an embodiment is shown in which the circuit 11 is located under water. The entire heat conversion unit 7 is positioned on the seabed. This embodiment has an advantage that the seawater intake pipeline 14 and discharge pipeline 16 can be very short, which advantageously limits energy loss in the transport of the seawater through the seawater intake pipeline 14 to the condenser and from the condenser through the seawater discharge pipeline 16. Furthermore, this embodiment has an advantage that electric energy can be created at the seabed if it is needed at the seabed. This obviates an electric cable extending from the water surface to the seabed.

In another embodiment, the circuit is located on shore.

The evaporator may have a construction which is known per se and may comprise an evaporator working fluid channel, the hydrocarbons channel which is discussed above and a heat-conducting evaporator wall which separates the evaporator working fluid channel from the hydrocarbons channel. The evaporator may operate in counter flow.

The condenser may also have a construction which is known per se and may comprises a condenser working fluid channel, a water channel and a heat-conducting condenser wall which separates the condenser working fluid channel from the water channel.

At the downstream end of the hydrocarbons processing installation 10, an export pipeline 21 is provided which runs down to the seabed and which extends to a delivery point at sea or on land. A pump 20 is provided to pump the hydrocarbons through the export pipeline. The energy for the pump 20 may also be provided by the system 100.

The present invention also relates to the offshore facility 6 comprising the system 100 of any of the preceding claims. The offshore facility may be above the water surface as shown in FIG. 1 or below the water surface as shown in FIG. 2.

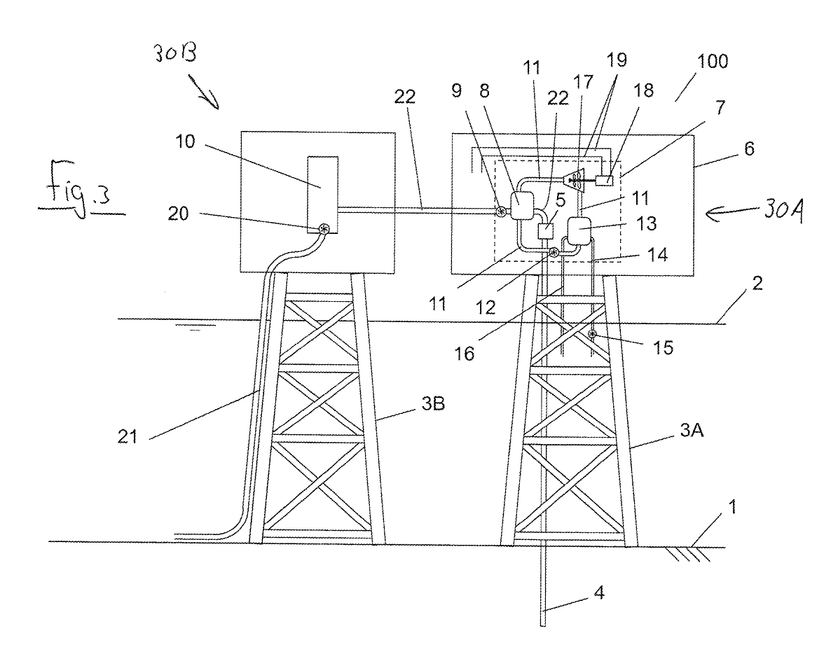

Turning to FIG. 3, an embodiment is shown having separate platforms 30A, 30B which are supported by separate structures 3A and 3B.

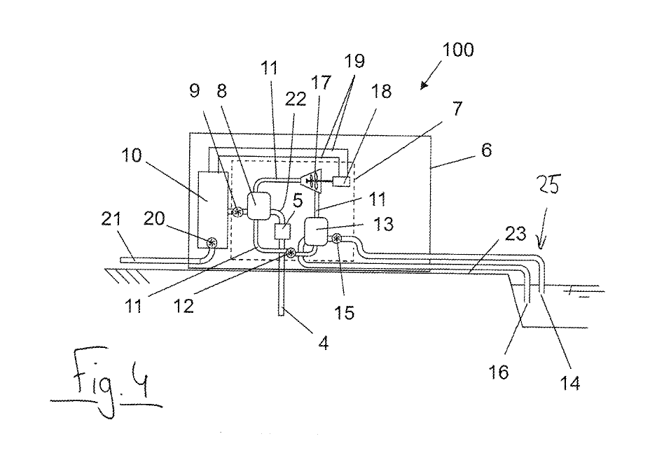

Turning to FIG. 4, the system 100 may also be based on land. The water intake 25 comprises a pipeline 14 which extends to sea, or alternatively to a lake or river. The well 4 may be a subsea well or a well on land. The electric energy may be used for various purposes.

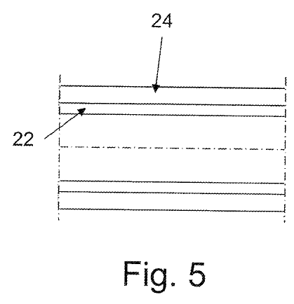

Turning to FIG. 5, the pipeline 22 is shown with heat insulation 24 around it. The heat insulation 24 may of any suitable material, such as PE or PP.

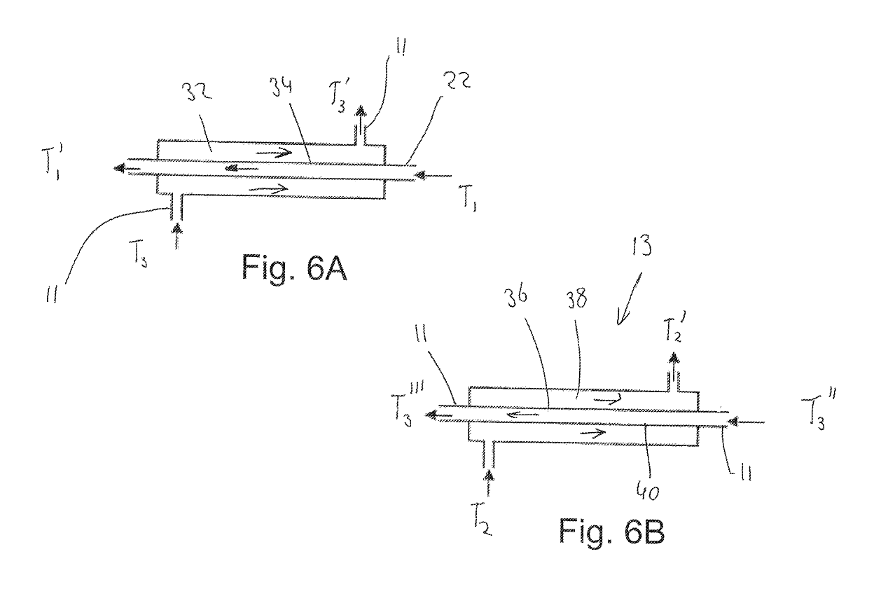

Turning to FIG. 6A, a diagrammatic view of the evaporator 8 is shown. The hydrocarbons flow through the pipeline 22 and enter the heat exchanger at a temperature T1. The working fluid flows in counter flow through the channel 32 which is provided around the pipeline 22. The wall 34 conducts heat from the hydrocarbons to the working fluid and raises the temperature of the working fluid from T3 to T3′. The temperature of the hydrocarbons drops from T1 to T1′ as the result of the heat transfer.

Turning to FIG. 6B, a diagrammatic view of the condenser 13 is shown. The working fluid flows through the central channel 36 and enters the condenser at a temperature T3″. The (sea)water flows in counter flow through the outer channel 38 which is provided around the central channel 36. The wall 40 conducts heat from the working fluid to the (sea)water and lowers the temperature of the working fluid from T3″ to T3″. The temperature of the (sea)water rises from T2 to T2′ as the result of the heat transfer.

Both for the evaporator and the condenser other configurations may be possible, for instance with a large number of channels, cross flow and other configurations which are known in the field of heat exchangers.

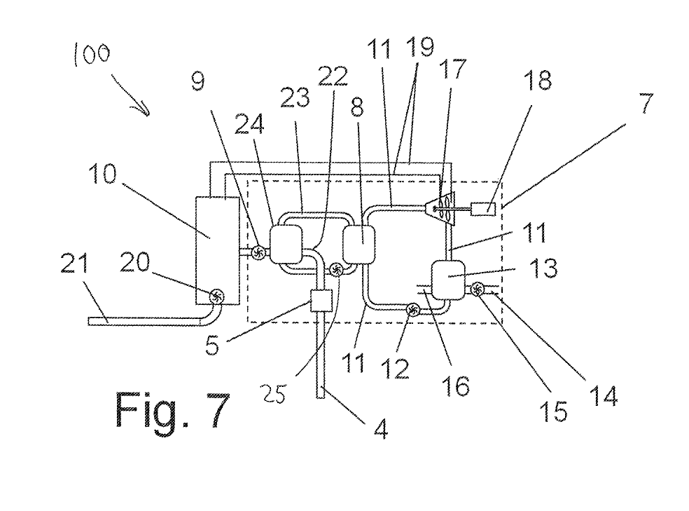

Turning to FIG. 7, another embodiment is shown. This embodiment has a second, intermediate circuit 23. The intermediate circuit 23 is a closed circuit and contains a second, intermediate working fluid, in particular water. A second pump 25 is provided to circulate the second fluid.

The intermediate circuit 23 is configured to transfer heat from the hydrocarbons to the working fluid in the circuit 11, which is referred to as the “main circuit 11” in this embodiment. The embodiment also comprises an extra heat exchanger 24, which can be of the same type as the heat exchanger shown in FIG. 6A. In the extra heat exchanger 24, the heat from the hydrocarbons is transferred to the second working fluid. The second working fluid is then conveyed through the intermediate circuit 23 to the evaporator 8 where the heat is transferred to the “main” working fluid.

One advantage of this configuration is that it provides more freedom of choice for the evaporator 8. From time to time, the evaporator 8 needs to be cleaned and for this reason needs to be opened. If—as is done in the first embodiment—in the evaporator 8 heat is transferred from hydrocarbons to ammonia (or another working fluid), both the hydrocarbon channel and the ammonia channel may need cleaning after a while. However, very few evaporators exit for which both channels can be opened. Therefore, only a limited choice exists for the evaporator.

In the embodiment of FIG. 7, evaporator 8 can be of a type for which only one channel can be opened for cleaning, because the channel of the intermediate circuit 23 may contains clean water which does not contaminate the water channel in the evaporator 8. Therefore, more freedom is available in choosing an evaporator.

A second advantage of this embodiment is that the system 100 as a whole has more flexibility in case of temperature variations of the hydrocarbons. The intermediate circuit 23 can be used to regulate the heat transfer.

### Operation

In operation, the method of generating electrical energy comprises the following steps:
positioning the system 100 according to the invention near a subsea well 4, connecting the system to the subsea well and letting hydrocarbons flow through the hydrocarbons pipeline 22. The location may be a location at sea, either above the water or below the water, in particular on the seabed. Alternatively, the system may be placed on shore.
circulating the working fluid through the circuit 11,
evaporating the working fluid with the heat from the hydrocarbons in the evaporator 8, passing the evaporated working fluid through the turbine 17 and creating electric energy with the turbine and the electric generator 18, and condensing the working fluid with the seawater in the condenser 13.

The hydrocarbons may be processed in a hydrocarbons processing installation 10 which is situated downstream from the evaporator, wherein the electric generator 18 is coupled to the processing installation 10 via one or more electric energy conductors 19. Electric energy which is generated by the electric generator is used by the hydrocarbons processing installation during the processing of the hydrocarbons.

The hydrocarbons are processed in the hydrocarbons processing installation 10 directly after transferring heat from the hydrocarbons to the working fluid in the evaporator. The section of pipeline between the evaporator and the hydrocarbons processing installation 10 can be very short, i.e. less than 50 meter.

The hydrocarbons processing installation 10 and the circuit 11 may be provided on the same platform. Alternatively, the hydrocarbons processing installation 10 and the circuit 11 may be provided on different platforms.

In shallower waters, the wellheads 5 are often placed on a wellhead platform and the processing installation 10 on a production or processing platform. The circuit 11 can be placed on either platform, just where it is most effective.

The hydrocarbon temperature (T1) may be higher than 80 degrees, in particular higher than 120 degrees Celsius. Some fields are found having temperatures in excess of 150 degrees Celsius. The seawater temperature (T2) may be lower than 25 degrees, in particular lower than 15 degrees Celsius. Obviously, the higher the temperature difference is, the more efficient the energy conversion will be.

The circuit may be operated on the basis of a Rankine cycle. However, other cycles are also possible, such as the Kalina cycle. The working fluid may be ammonia or any other working fluid or mixture of working fluids having a low boiling temperature.

After the hydrocarbons have been processed in the hydrocarbons processing installation 10, the hydrocarbons are conveyed to shore or to another location via an export pipeline 21. A pump 20 may be used to pump the hydrocarbons through the export pipeline 21.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising i.e., open language, not excluding other elements or steps.

Any reference signs in the claims should not be construed as limiting the scope of the claims or the invention. It will be recognized that a specific embodiment as claimed may not achieve all of the stated objects.

The mere fact that certain measures are recited in mutually different dependent claims does not indicate that a combination of these measures cannot be used to advantage.

1.-24. (canceled)

25. A system for generating electrical energy, the system comprising:
a circuit containing a working fluid;
an evaporator configured for boiling the working fluid;
a turbine driven by the vaporized working fluid and an electric generator coupled to the turbine for creating electric energy;
a condenser for condensing the working fluid which flows from the turbine, and
a pump for pumping the working fluid through the circuit, wherein the evaporator, the turbine, the condenser and the pump are positioned along the circuit; and
a hydrocarbons pipeline connected to a well, wherein the hydrocarbons pipeline transports hydrocarbons having a hydrocarbon temperature from the well;
a water intake configured for taking in water having a water temperature, in particular seawater, wherein the hydrocarbon temperature is higher than the water temperature; and
a water discharge configured for discharging the water,
wherein the water intake is in fluid communication with a water channel in the condenser, the condenser being configured to transfer heat from the working fluid to the water to condense the working fluid, and wherein the condenser is in fluid communication with the water discharge for discharging the used water,
wherein the hydrocarbons pipeline is in fluid communication with a hydrocarbons channel in the evaporator, and wherein the evaporator is configured for transferring heat from the hydrocarbons to the working fluid in the evaporator in order to boil the working fluid.

26. The system according to any claim 25, further comprising a hydrocarbons processing installation which is positioned downstream from the evaporator, wherein the hydrocarbons are processed in the hydrocarbons processing installation after having transferred heat to the working fluid in the evaporator.

27. The system according to claim 26, wherein the electric generator is coupled to the hydrocarbons processing installation via one or more electric energy conductors, and wherein electric energy which is generated by the electric generator is used by the hydrocarbons processing installation in the processing of the hydrocarbons.

28. The system according to claim 25, wherein the circuit is provided at sea, wherein the well is a subsea well, wherein the water intake is a seawater intake, and wherein the water discharge is a seawater discharge.

29. The system according to claim 26, wherein the hydrocarbons processing installation and the circuit are provided on a common offshore facility at sea.

30. The system according to claim 29, wherein the circuit is located above the water level.

31. The system according to claim 30, wherein the offshore facility is floating or supported by a structure which rests on the seabed.

32. The system according to claim 25, wherein the circuit is integrated in an offshore facility which is located under water.

33. The system according to claim 32, wherein the offshore facility rests on the seabed.

34. The system according to claim 29, wherein the electricity which is generated in the electric generator is used for general purposes on the offshore facility.

35. The system according to claim 25, wherein the circuit is located on shore.

36. The system according to claim 25, wherein the water intake comprises a pump which is located below a water surface.

37. The system according to claim 25, wherein the water intake is located near the well.

38. The system according to claim 25, wherein the evaporator comprises an evaporator working fluid channel, the hydrocarbons channel, and a heat-conducting evaporator wall which separates the evaporator working fluid channel from the hydrocarbons channel, and wherein the condenser comprises a condenser working fluid channel, a water channel, and a heat-conducting condenser wall which separates the condenser working fluid channel from the water channel.

39. The system according to claim 25, wherein the hydrocarbons pipeline is covered with thermal insulation to limit heat loss during transport to the evaporator.

40. The system according to claim 25, further comprising:
a second, intermediate circuit between the hydrocarbon pipeline and the circuit; and
an additional heat exchanger, the second, intermediate circuit being configured to transfer heat from the hydrocarbons to the working fluid in the circuit via a second working fluid which is different from the first working fluid and which is in particular water.

41. An offshore facility comprising the system of claim 25.

42. The offshore facility according to claim 41, further comprising a hydrocarbons processing installation.

43. The offshore facility according to claim 42, wherein the circuit and the hydrocarbons processing installation are placed in different platforms.

44. A method of generating electrical energy, the method comprising:
positioning the system of claim 25 near a well;
connecting the system to the well and letting hydrocarbons flow through the hydrocarbons pipeline;
circulating the working fluid through the circuit;
evaporating the working fluid with the heat from the hydrocarbons in the evaporator;
passing the evaporated working fluid through the turbine and creating electric energy with the turbine and the electric generator; and
condensing the working fluid with the seawater in the condenser.

45. The method according to claim 44, wherein the hydrocarbons are processed in a hydrocarbons processing installation which is situated downstream from the evaporator, wherein the electric generator is coupled to the hydrocarbons processing installation via one or more electric energy conductor, and wherein electric energy which is generated by the electric generator is used by the hydrocarbons processing installation during the processing of the hydrocarbons.

46. The method according to claim 45, wherein the hydrocarbons are processed in the hydrocarbons processing installation directly after having transferred heat from the hydrocarbons to the working fluid in the evaporator.

47. The method according to claim 45, wherein the hydrocarbons processing installation and the circuit are provided on the same platform.

48. The method according to claim 44, wherein the hydrocarbon temperature is higher than 80 degrees, in particular higher than 120 degrees Celsius, and wherein the seawater temperature is lower than 25 degrees, in particular lower than 15 degrees Celsius.
